(19) United States
(12) Patent Application Publication
(10) Pub. No.: US 2016/0299461 A1
(43) Pub. Date: Oct. 13, 2016

(54) Heater Frame for a Fuser Assembly and Methods of Using Same

(71) Applicant: Lexmark International, Inc., Lexington, KY (US)

(72) Inventors: Jeffery James Buchanan, Lexington, KY (US); Benjamin Karnik Johnson, Lexington, KY (US); Alexander Douglas Meade, Lexington, KY (US)

(21) Appl. No.: 14/934,284

(22) Filed: Nov. 6, 2015

Related U.S. Application Data
(60) Provisional application No. 62/145,004, filed on Apr. 9, 2015.

(51) Int. Cl. G03G 15/20

(52) U.S. Cl. CPC G03G 15/2053

(57) ABSTRACT

A fuser assembly including a heat transfer member and a backup member disposed relative each other for forming a fusing nip, the heat transfer member comprising: a heater member, a housing to which the heater member is attached; a frame connected to the housing; and a rotatable endless belt disposed around the heater member, housing, and frame, wherein a the frame includes a plurality of cutout geometries disposed along a length thereof for tuning a stiffness thereof, and wherein the stiffness of the frame is about 350 N/mm to about 750 N/mm.

### CROSS REFERENCES TO RELATED APPLICATIONS

The present application is related to and claims priority under 35 U.S.C. 119(e) from U.S. provisional application number 62/145,004, filed Apr. 9, 2015, entitled, “Heater frame for a fuser assembly, and methods of using same,” the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to a fuser assembly including a frame connected to the housing to which a heater member is attached, and particularly, to a frame having a three point stiffness tuned by means of cutout geometries.

2. Description of the Related Art

In electrophotographic image forming devices, such as a printer or copier, a latent image is formed on a light sensitive drum and developed with toner. The toner image is then transferred onto media, such as a sheet of paper, and is subsequently passed through a fuser assembly where heat and pressure are applied to melt and to adhere the unfused toner to the surface of the media. There are a variety of devices to apply heat and pressure to the media such as radiant fusing, convection fusing, and contact fusing. One type of contact fusing, belt fusing assemblies, have been used in imaging devices. In one configuration of a belt fusing assembly, a heater, such as a ceramic heater, may be supported on a supporting member, and a backup roll may be pressed against the heating element with a thin film belt member therebetween. Heat from the heat source may pass through the thin film to heat and adhere unfixed toner to a medium as the medium is passed between the pressure roll and the belt.

In a belt fusing assembly, it is known that increased back-up roll (BUR) penetration by the belt leads to increased media velocity in the nip for the same BUR core angular velocity. When the frame of the fusing member flexes or bows away from the BUR from contact therewith, the penetration of the heat transfer member with respect to the BUR is reduced near the center of the page, assuming the bending is centered relative to media. Toward the edges where penetration is highest, the media is driven at the highest velocity. In the center of the fusing nip where penetration is lowest, the media velocity lags behind the to edges. The resulting velocity gradient being induced in the media due to the variable nip penetration tends to stretch the media thus opposing the tendency of soft, humid paper to corrugate and possibly wrinkle in the fusing nip.

### SUMMARY

Example embodiments of the present disclosure include systems having reduced heater frame stiffness to allow variation of the penetration of the heat transfer member into the backup roll across the fusing nip and thereby prevent sheet wrinkling.

According to an example embodiment, there is disclosed a fuser assembly including a heat transfer member and a backup member disposed relative to the heat transfer member for forming a fusing nip. The heat transfer member includes a heater member; a housing to which the heater member is attached; a frame connected to the housing; and a rotatable endless belt disposed around the heater member, housing, and frame.

In an example embodiment, the frame has a three point stiffness between about 350 N/mm and about 750 N/mm. In one aspect, a ratio of the three point stiffness of the frame relative to the total loading of the fusing nip is between about 1.0 mm⁻¹ and about 1.9 mm⁻¹. In the present disclosure, the frame and the heater member bow away from the backup member between about 0.30 mm to about 0.40 mm at the center thereof, and a ratio of bending at a center of the heater member to a length of the heater member is between about 1.2e-3 and about 1.8e-3. In an example embodiment, a center of the heater member is about 0.25 mm further from a center of the backup member than opposite ends of the heater member.

A three point stiffness of the frame may be tuned via a plurality of cutout geometries disposed along a length of the frame, such as, for example, a plurality of apertures, a plurality of notches, or a combination of both.

### BRIEF DESCRIPTION OF THE DRAWINGS

The above-mentioned and other features and advantages of the disclosed example embodiments, and the manner of attaining them, will become more apparent and will be better understood by reference to the following description of the disclosed example embodiments in conjunction with the accompanying drawings, wherein:

FIG. 1 is a side elevational view of an imaging device according to an example embodiment.

FIG. 2 is cross-sectional view of a fuser assembly of the imaging device of FIG. 1 according to an example embodiment.

FIG. 3 is a perspective view of a heat transfer member of the fuser assembly of FIG. 1.

FIG. 4 is a cross-sectional view of the heat transfer member of FIG. 3.

FIGS. 5-8 are perspective views of a frame of the heat transfer member of FIG. 2 according to example embodiments of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and positionings. In addition, the terms “connected” and “coupled” and variations thereof are not restricted to physical or mechanical connections or couplings.

Spatially relative terms such as “top”, “bottom”, “front”, “back” and “side”, and the like, are used for ease of description to explain the positioning of one element relative to a second element. Terms such as “first”, “second”, and the like, are used to describe various elements, regions, sections, etc. and are not intended to be limiting. Further, the terms “a” and “an” herein do not denote a limitation of quantity, but rather denote the presence of at least one of the referenced item.

Furthermore, and as described in subsequent paragraphs, the specific to configurations illustrated in the drawings are intended to exemplify embodiments of the disclosure and that other alternative configurations are possible.

Reference will now be made in detail to the example embodiments, as illustrated in the accompanying drawings. Whenever possible, the same reference numerals will be used throughout the drawings to refer to the same or like parts.

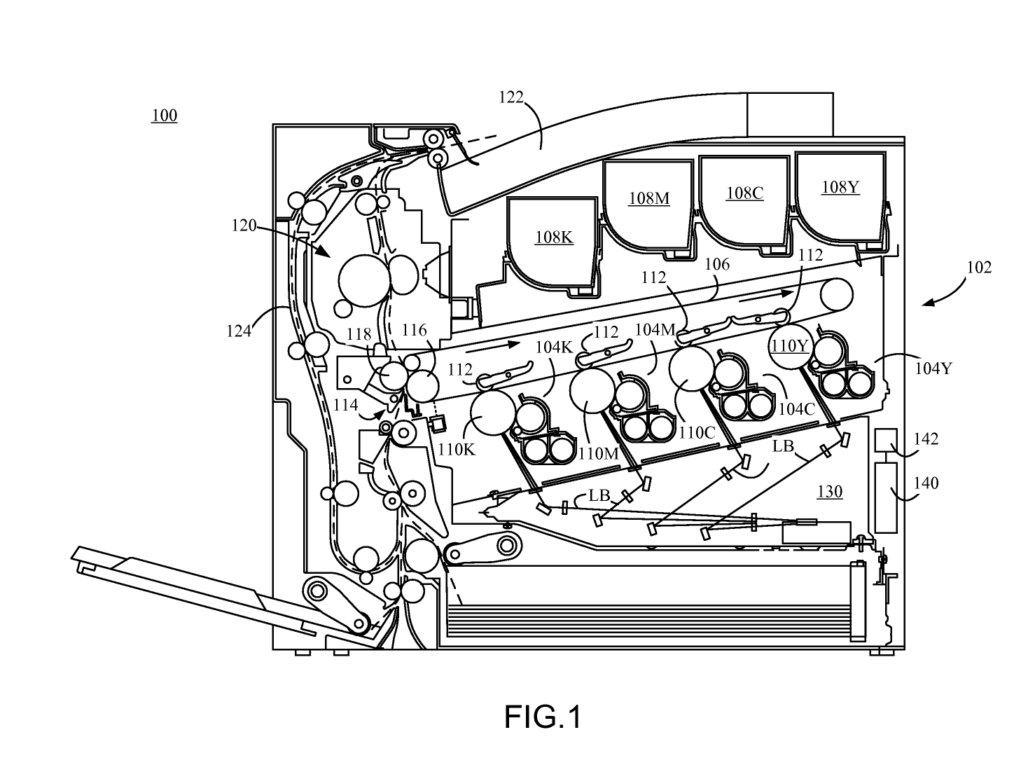

FIG. 1 illustrates a color imaging device 100 according to an example embodiment. Imaging device 100 includes a first toner transfer area 102 having four developer units 104 that substantially extend from one end of imaging device 100 to an opposed end thereof. Developer units 104 are disposed along an intermediate transfer member (ITM) 106. Each developer unit 104 holds a different color toner. The developer units 104 may be aligned in order relative to the direction of the ITM 106 indicated by the arrows in FIG. 1, with the yellow developer unit 104Y being the most upstream, followed by cyan developer unit 104C, magenta developer unit 104M, and black developer unit 104K being the most downstream along ITM 106.

Each developer unit 104 is operably connected to a toner reservoir 108 for receiving toner for use in a printing operation. Each toner reservoir 108 is controlled to supply toner as needed to its corresponding developer unit 104. Each developer unit 104 is associated with a photoconductive member 110 that receives toner therefrom during toner development to form a toned image thereon. Each photoconductive member 110 is paired with a transfer member 112 for use in transferring toner to ITM 106 at first transfer area 102.

During color image formation, the surface of each photoconductive member 110 is charged to a specified voltage, such as −800 volts, for example. At least one laser beam LB from a printhead or laser scanning unit (LSU) 130 is directed to the surface of each photoconductive member 110 and discharges those areas it contacts to form a latent image thereon. In one embodiment, areas on the photoconductive member 110 illuminated by the laser beam LB are discharged to approximately −100 volts. The developer unit 104 then transfers toner to photoconductive member 110 to form a toner image thereon. The toner is attracted to the areas of the surface of photoconductive member 110 that are discharged by the laser beam LB from LSU 130.

ITM 106 is disposed adjacent to each of developer unit 104. In this embodiment, ITM 106 is formed as an endless belt disposed about a drive roller and other rollers. During image forming or imaging operations, ITM 106 moves past photoconductive members 110 in a clockwise direction as viewed in FIG. 1. One or more of photoconductive members 110 applies its toner image in its respective color to ITM 106. For mono-color images, a toner image is applied from a single photoconductive member 110K. For multi-color images, toner images are applied from two or more photoconductive members 110. In one embodiment, a positive voltage field formed in part by transfer member 112 attracts the toner image from the associated photoconductive member 110 to the surface of moving ITM 106.

ITM 106 rotates and collects the one or more toner images from the one or more developer units 104 and then conveys the one or more toner images to a media sheet at a second transfer area 114. Second transfer area 114 includes a second transfer nip formed between at least one back-up roller 116 and a second transfer roller 118.

Fuser assembly 120 is disposed downstream of second transfer area 114 and receives media sheets with the unfused toner images superposed thereon. In general terms, fuser assembly 120 applies heat and pressure to the media sheets in order to fuse toner thereto. After leaving fuser assembly 120, a media sheet is either deposited into output media area 122 or enters duplex media path 124 for transport to second transfer area 114 for imaging on a second surface of the media sheet.

Imaging device 100 is depicted in FIG. 1 as a color laser printer in which toner is transferred to a media sheet in a two-step operation. Alternatively, imaging device 100 may be a color laser printer in which toner is transferred to a media sheet in a single-step process—from photoconductive members 110 directly to a media sheet. In another alternative embodiment, imaging device 100 may be a monochrome laser printer which utilizes only a single developer unit 104 and photoconductive member 110 for depositing black toner directly to media sheets. Further, imaging device 100 may be part of a multi-function product having, among other things, an image scanner for scanning printed sheets.

Imaging device 100 further includes a controller 140 and memory 142 communicatively coupled thereto. Though not shown in FIG. 1, controller 140 may be coupled to components and modules in imaging device 100 for controlling same. For to instance, controller 140 may be coupled to toner reservoirs 108, developer units 104, photoconductive members 110, fuser assembly 120 and/or LSU 130 as well as to motors (not shown) for imparting motion thereto. It is understood that controller 140 may be implemented as any number of controllers and/or processors for suitably controlling imaging device 100 to perform, among other functions, printing operations.

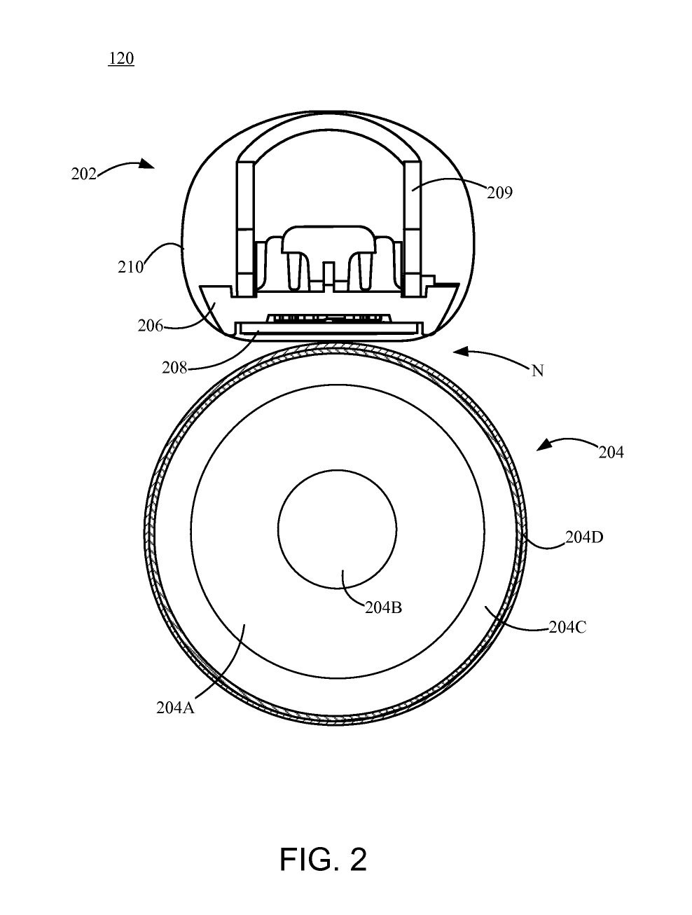

With respect to FIG. 2, in accordance with an example embodiment, there is shown a fuser assembly 120 for use in fusing toner to sheets of media in an electrophotographic device through applications of heat and pressure. Fuser assembly 120 may include a heat transfer member 202 and a backup roll 204 cooperating with the heat transfer member 202 to define a fuser nip N for conveying media sheets therein. Heat transfer member 202 may include a housing 206, a heater member 208 supported on or at least partially in housing 206, a frame 209 to which housing 206 is connected, and an endless flexible fuser belt 210 positioned about housing 206, heater member 208 and frame 209. Heater member 208 may be formed from a substrate of ceramic or like material to which one or more resistive traces is secured which generates heat when a current is passed through the resistive trace. The inner surface of fuser belt 210 contacts the outer surface of heater member 208 so that heat generated by heater member 208 heats fuser belt 210. Heater member 208 may further include at least one temperature sensor, such as a thermistor (not shown), coupled to the substrate for detecting a temperature of heater member 208. It is understood that, alternatively, heater member 208 may be implemented using other heat-generating mechanisms.

Fuser belt 210 is disposed around housing 206, heater member 208 and frame 209. Backup roll 204 contacts fuser belt 210 such that fuser belt 210 rotates about housing 206 and heater member 208 in response to backup roll 204 rotating. Backup roll 204 may be biased against fuser belt 210 using one or more springs (not shown) for creating sufficient pressure/loading for use in performing a fusing operation. With fuser belt 210 rotating around housing 206 and heater member 208, the inner surface of fuser belt 210 contacts heater member 208 so as to heat fuser belt 210 to a temperature sufficient to combine with the above-described loading for performing a fusing operation to fuse toner to sheets of media.

Heat transfer member 202, fuser belt 210, and backup roll 204 may be constructed from the elements and in the manner as disclosed in U.S. Pat. No. 7,235,761, the content of which is incorporated by reference herein in its entirety.

Backup roll 204 may include a metal core 204A, having a diameter of about 30 mm and a protruding bearing shaft 204B of about 10 mm in diameter. A layer 204C of rubber material having a thickness of about 5 mm is disposed about metal core 204A. A sleeve 204D constructed from polyperfluoroalkoyx-tetrafluoroethylene (PFA) may surround rubber layer 204C.

Backup roll 204 may be driven by a motor (not shown) operatively connected to controller 140. The motor may be any of a number of different types of motors. For instance, the motor may be a brushless D.C. motor or a stepper motor. The motor may be coupled to backup roll 204 by gearing (not shown).

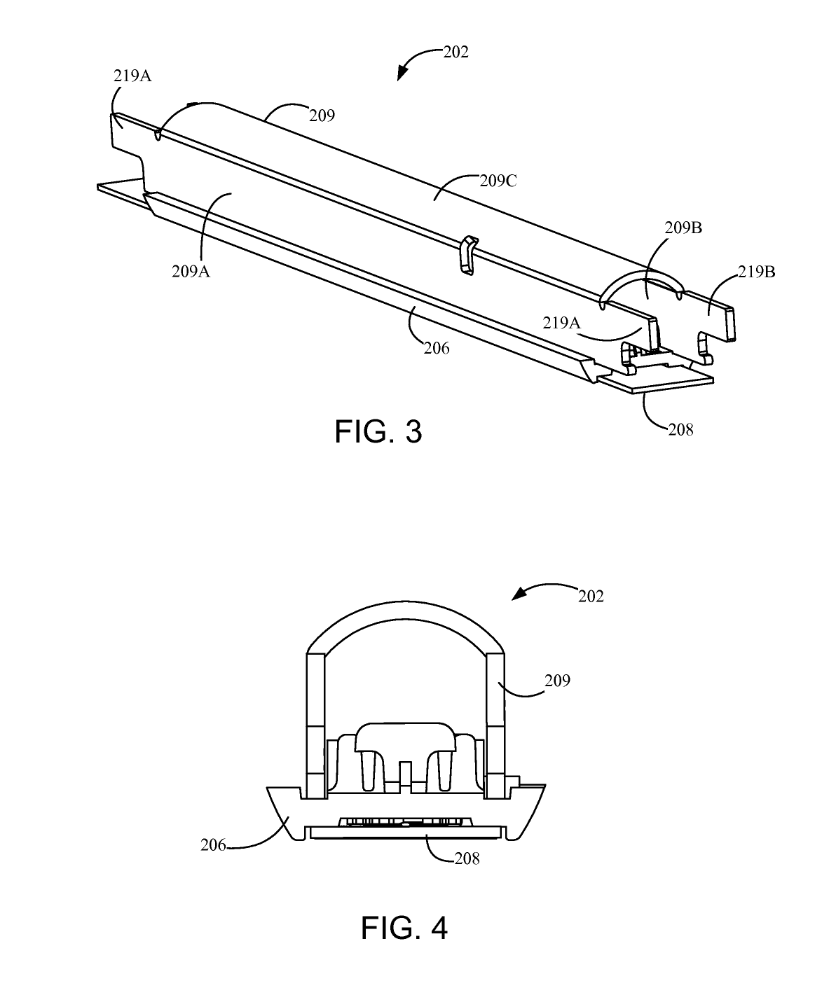

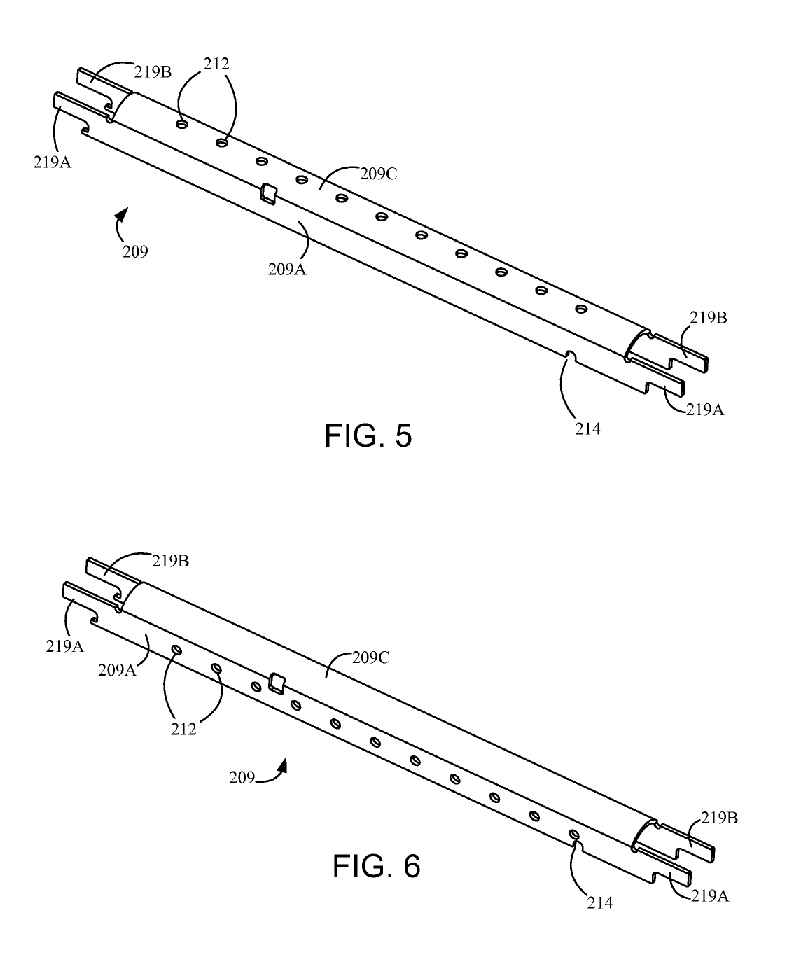

Frame 209 is formed from a metal, such as steel, and includes opposing leg parts 209A and 209B, and a base part 209C joining upper edges of the leg parts 209A and 209B so as to define a generally inverted U-shaped member, as shown in FIG. 3. Leg part 209A includes end portions 219A, and leg part 209B includes end portions 219B. As shown in FIGS. 2-4, frame 209 is positioned over, covers and extends from housing 206, and may be connected to housing 206 using any of a number of known techniques. In an example embodiment, frame 209 and housing 206 are integrally formed as a single unit.

It is difficult to either model or measure the deflection profile of the heater frame 209 which results from contact with backup roll 204. Also, it is impractical to specify a heater frame section modulus (for the purpose of an analytical analysis) since the heater frame will not be prismatic in reality. Nevertheless, equipment for testing the mechanical properties of material, such as machines by Instron®, can accurately measure the load versus center deflection of a given heater frame in three point bending (supported at points respective of the actual fuser assembly), thus providing an objectively measured value of frame stiffness. A strong correlation exists between measured frame three point bending stiffness and nip width variation from center to edge (resulting from the above-mentioned backup roll penetration gradient). Testing of nip width variation versus treeing performance provides the means to determine an improved nip width variation from center to edge. Once the improved variation has been determined, the correlation may be used to obtain the desired frame three point bending stiffness.

According to an example embodiment shown in FIGS. 3-8, frame 209 exhibits to a three point bending stiffness (loaded at the midpoint and supported at end points respective of and corresponding to fuser assembly 120) between about 350 N/mm to about 750 N/mm, and particularly between about 450 N/mm and 650 N/mm, such as about 550 N/mm. In an example embodiment, frame 209 exhibits a ratio of three point bending stiffness to total fuser nip loading of about 1.0 mm⁻¹ to about 1.9 mm^{31 1}, and particularly between about 1.4 mm⁻¹ and about 1.6 mm⁻¹.

Further, heater member 208, housing 206 and frame 209 bow away from backup roll 204 such that the center of the heater member 208 is more than about 0.25 mm further from backup roll 204 than the ends of heater member 208, such as by about 0.30 mm to about 0.40 mm Heater member 208 bows away from backup roll 204 such that the ratio of bending at the center of heater member 208 to heater length is more than about 1.0e-3 (mm/mm), such as between about 1.2e-3 to about 1.8e-3.

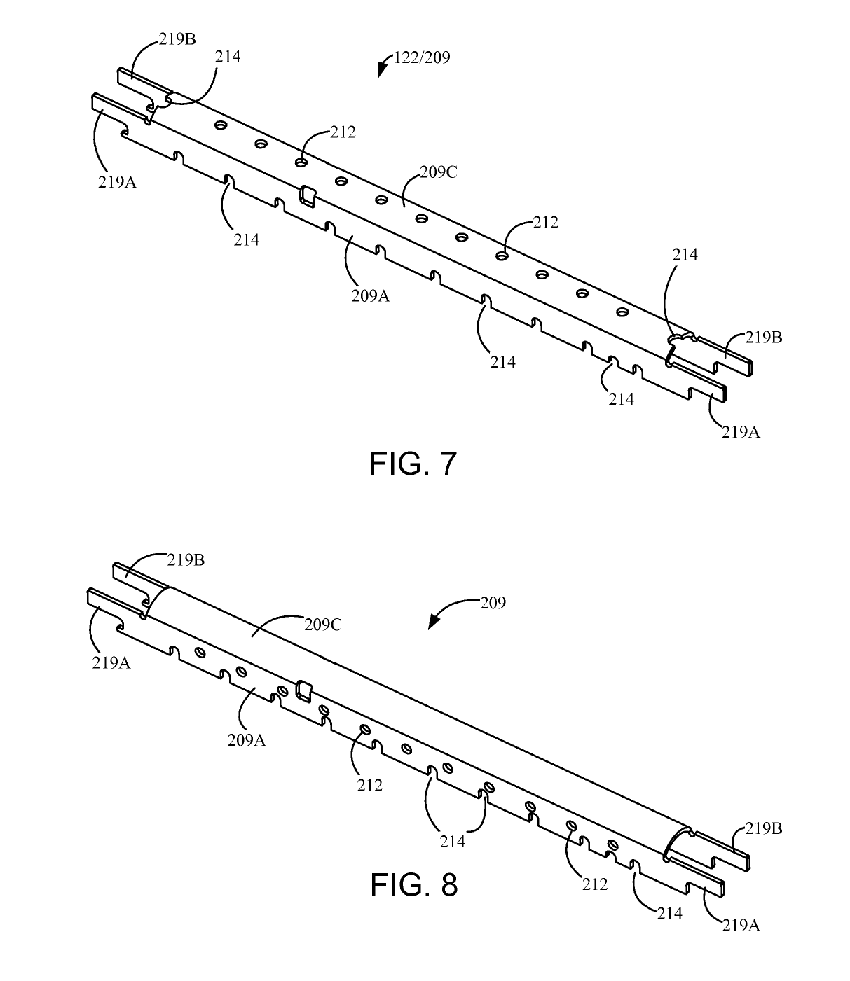

In an example embodiment, the stiffness of frame 209 is at least partly tuned by means of one or more frame cutout geometries. A frame cutout geometry may be an aperture 212 or a notch 214. Plural frame cutout geometries may vary in size, shape and position along a length of frame 209, and may include, for example, one or more apertures 212, one or more notches 214, and/or a combination of both, as shown in FIGS. 5-8. In having one or more frame cutout geometries arranged along frame 209, a stiffness of frame 209 may be controlled, allowing frame 209 to bend when in fuser assembly 120. Consequently, with frame 209 bending in fuser assembly 120, penetration of the heat transfer member 202, and in particular fuser belt 210, into backup roll 204 varies across fuser nip N and causes a media sheet to be stretched so as to avoid wrinkling. In one example embodiment, a plurality of apertures 212 are disposed along the base part 209C (FIGS. 5 and 7) and leg parts 209A and 209B (FIGS. 6 and 8) of frame 209. As shown, the plurality of apertures 212 may be spaced, for example, about 17.5 mm from each other. Apertures 112 may vary in size and shape, and distribution along frame 209. It is understood that in addition or in the alternative, a plurality of notches 214 may be used along leg parts 209A, 209B and/or base part 209C (FIGS. 7 and 8).

In addition, the example embodiments above are described as controller 140 being separate from but communicatively coupled to fuser assembly 120 on the imaging device. In an alternative embodiment, controller 140 is mounted on or within fuser assembly 120 and may form part thereof.

The description of the details of the example embodiments have been described in the context of a color electrophotographic imaging devices. However, it will be appreciated that the teachings and concepts provided herein are applicable to monochrome electrophotographic imaging devices and multifunction products employing electrophotographic imaging.

The foregoing description of several example embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A fuser assembly, comprising:
a heat transfer member, comprising:
a heater member;
a housing to which the heater member is attached;
a frame extending from the housing; and
a rotatable endless belt disposed around the heater member, housing and frame; and
a backup member which forms a fusing nip with the heat transfer member,
wherein the frame has a three point stiffness such that a ratio of the three point stiffness of the frame to total loading of the fusing nip is between about 1.0 mm⁻¹ and about 1.9 mm⁻¹.

2. The fuser assembly of claim 1, wherein the three point stiffness of the frame is between about 350 N/mm and about 750 N/mm.

3. The fuser assembly of claim 1, wherein the frame and heater member bow away from the backup member between about 0.30 mm and about 0.40 mm.

4. The fuser assembly of claim 1, wherein a center of the heater member is about 0.25 mm further from a center of the backup member than opposite ends of the heater member.

5. The fuser assembly of claim 1, wherein the frame and the heater member bow away from the backup member such that a ratio of bending at a center of the heater member to a length of the heater member is between about 1.2e-3 and about 1.8e-3.

6. The fuser assembly of claim 1, wherein the frame includes a one or more cutout geometries positioned along a length thereof for tuning the three point stiffness of the frame.

7. The fuser assembly of claim 6, wherein the one or more cutout geometries comprises a plurality of cutout geometries arranged along the frame with each cutout geometry being spaced at about 17.5 mm from an adjacent cutout geometry.

8. A fuser assembly, comprising:
a heat transfer member, comprising
a heater member;
a housing to which the heater member is attached;
a frame covering the housing; and
a rotatable endless belt disposed around the heater member, housing and frame;
a backup member disposed within the fuser assembly so that a fuser nip is formed between the backup member and heat transfer member,
wherein the frame has a three point stiffness between about 350 N/mm and about 750 N/mm.

9. The fuser assembly of claim 8, wherein the ratio of the three point stiffness of the frame to total loading of the fuser nip is between about 1.0 mm⁻¹ and about 1.9 mm⁻¹.

10. The fuser assembly of claim 8, wherein the frame and the heater member bow away from the backup member between about 0.30 mm to about 0.40 mm.

11. The fuser assembly of claim 8, wherein the frame and the heater member bow away from the backup member such that a center of the heater member is more than about 0.25 mm further from the backup member than opposite ends of the heater member.

12. The fuser assembly of claim 8, wherein the frame and the heater member bow away from the backup member such that a ratio of bending at a center of the heater member to a length of the heater member is between about 1.2e-3 and about 1.8e-3.

13. The fuser assembly of claim 8, wherein the frame includes a plurality of cutout geometries for tuning the three point stiffness of the frame and being arranged along the frame such that each of the plurality of cutout geometries is spaced at about 17.5 mm from an adjacent cutout geometry.

14. The fuser assembly of claim 8, wherein the stiffness of the frame is between about 450 N/mm and about 650 N/mm.

15. A fuser assembly, comprising:
a heat transfer member, comprising
a heater member;
a housing to which the heater member is attached;
a frame for containing the housing; and
a rotatable endless belt disposed around the heater member, housing and frame; and
a backup member disposed relative to the heat transfer member so that a fusing nip is formed between the backup member and heat transfer member,
wherein the frame and heater member bow away from the backup member between about 0.30 mm to about 0.40 mm, and a ratio of bending at a center of the heater member to a length of the heater member is between about 1.2e-3 and about 1.8e-3.

16. The fuser assembly of claim 15, wherein the stiffness of the frame is between about 350 N/mm and about 750 N/mm.

17. The fuser assembly of claim 15, wherein a ratio of the three point stiffness of the frame to a total loading of the fusing nip is between about 1.0 mm⁻¹ and about 1.9 mm⁻¹.

18. The fuser assembly of claim 15, wherein the frame includes a plurality of cutout geometries positioned along a length thereof and spaced about 17.5 mm apart.

19. The fuser assembly of claim 15, wherein the frame includes one or more cutout geometries, the one or more cutout geometries including at least one aperture, at least one notch, or at least one aperture and at least one notch disposed along a length of the frame.

20. The fuser assembly of claim 18, wherein the frame and the housing are integrally formed as a single unit.
